(19) United States
(12) Patent Application Publication
(10) Pub. No.: US 2024/0294845 A1
(43) Pub. Date: Sep. 5, 2024

(54) VEHICLE CLEANING COMPOSITIONS

(71) Applicant: Energizer Auto, Inc., St. Louis, MO (US)

(72) Inventors: Qin Chen, Westerville, OH (US); Hirotaka Uchiyama, Loveland, OH (US); Jaeho Kim, Westlake, OH (US); James Aschenbener, Brooklyn, OH (US); Samantha Ream-Kissel, Brunswick, OH (US); Michael Campbell, Brecksville, OH (US)

(73) Assignee: Energizer Auto, Inc., St. Louis, MO (US)

(21) Appl. No.: 18/478,408

(22) Filed: Sep. 29, 2023

Related U.S. Application Data
(60) Provisional application No. 63/487,421, filed on Feb. 28, 2023.

(51) Int. Cl. C11D 1/14; C11D 1/90; C11D 3/40; C11D 3/50; C11D 11/00

(52) U.S. Cl. CPC C11D 1/146; C11D 1/90; C11D 3/40; C11D 3/50; C11D 2111/14

(57) ABSTRACT

The present disclosure describes a vehicle cleaning composition in solid form, a vehicle wash pack comprising a unit dose or multiple doses of the vehicle cleaning composition and a process for washing the surface of a vehicle using the vehicle cleaning composition.

### CROSS-REFERENCE TO RELATED APPLICATIONS

This application claims the benefit of U.S. Provisional Application No. 63/487,421 filed Feb. 28, 2023, which is incorporated herein by reference in its entirety.

### FIELD OF THE DISCLOSURE

The current disclosure discloses vehicle cleaning compositions in a solid form, and in a vehicle wash pack comprising a unit dose or multiple doses of the vehicle cleaning composition. The current disclosure also discloses a process for washing the surface of a vehicle using the vehicle cleaning composition.

### BACKGROUND OF THE DISCLOSURE

While the commercial polyvinyl alcohol (PVA in short) film-based water-soluble packs in laundry, and machine dishwashing cleaning products have been known for about two decades, the PVA film-based water-soluble packs for an exterior car wash have been difficult to develop.

The vehicle wash packs lack the comparable cleaning mechanical force, sustained warm water, and the multiple cleaning cycles (from rinsing, washing, to drying) often applied in the laundry and machine dishwashing. Such deficiencies require the vehicle wash packs to be able to dissolve in water rather quickly under temperatures such as 50° F. to 90° F. Such requirements become even more obvious when the powder vehicle wash packs are used for vehicle washing by hand. Prolonged agitation by hand and long dissolving time will make the vehicle washing application commercially less viable as the product loses the single-dose convenient-use benefits, which have been gaining more and more popularity among consumers and in e-commerce.

Because of such deficiencies, the vehicle wash packs have to rely on their own formulation to deliver the cleaning function. In addition, they must have the ability to avoid damage to the vehicle exterior paint coating and paint, and to the applied coatings such as wax, ceramic, and graphene coatings, under normal and elevated temperatures (e.g., 85° C.) during and after vehicle washing. Such damages could occur due to the potential interactions of the components of the vehicle wash formulation with the car exterior surface and its coatings, particularly at the elevated temperature as seen in some commercial car wash products.

Therefore, there is a need for a vehicle cleaning composition to meet the above requirements of quick dissolution in water at temperatures such as 50° F. to 90° F. and to avoid the above-mentioned disadvantages of damages to the vehicle exterior during and after vehicle washing. The present disclosure describes such a vehicle cleaning composition.

### SUMMARY OF THE DISCLOSURE

This Summary is provided to introduce a selection of concepts in a simplified form that is further described below in the Detailed Description. This Summary is not intended to identify all key features or essential features of the claimed subject matter, nor is it intended to be used alone as an aid in determining the scope of the claimed subject matter.

The present disclosure describes a vehicle cleaning composition comprising:
(i) at least one builder and/or foam stabilizer;
(ii) at least one surfactant selected from the group consisting of anionic surfactants and amphoteric surfactants;
(iii) at least one chelating agent; and optionally:
(iv) a fragrance source; and/or
(v) a dye;
wherein, the composition is in the form of a solid.

The present disclosure also describes a vehicle cleaning composition comprising:
(i) at least one builder and/or foam stabilizer, and optionally wherein the at least one builder and/or foam stabilizer is selected from the group consisting of one or more sugars, sodium carbonate, and sodium bicarbonate;
(ii) at least one surfactant selected from the group consisting of anionic surfactants and amphoteric surfactants, and optionally wherein the anionic surfactant is selected from the group consisting of sodium C₈-C₂₂ alkyl benzene sulfonate and sodium C₈-C₂₂ alkyl sulfate;
(iii) at least one hydrotropic additive; and optionally:
(iv) a fragrance source; and/or
(v) a dye;
wherein, the composition is in the form of a solid.

The present disclosure also discloses a vehicle wash pack comprising a unit dose or multiple doses of the compositions described herein.

The present disclosure also discloses a process for washing the surface of a vehicle using the compositions disclosed herein.

### BRIEF DESCRIPTION OF THE FIGURES

FIG. 1 shows an exemplary solid vehicle cleaning composition enclosed in a polymeric covering.

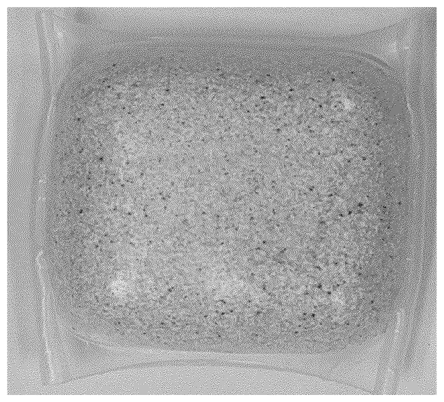

### DETAILED DESCRIPTION

As used herein “builders” in a cleaning composition are components that serve to upgrade and protect the cleaning efficiency of the surfactant(s) in the cleaning composition. Builders have a number of functions including softening, buffering, and emulsifying. Builders soften water by deactivating hardness minerals (metal ions like calcium and magnesium). They do this in one of two ways: sequestration and precipitation. Sequestration involves holding metal ions in solution, and precipitation involves removing metal ions from the solution as insoluble materials. In addition to softening, builders can also provide a desired level of alkalinity (increased pH) which aids in cleaning. They can also act as buffers to maintain proper alkalinity in wash water.

Builders can also help to emulsify oily soils by breaking them up into tiny globules. They can peptize or suspend loosened dirt and keep them from settling back on the cleaned surface.

Some common builders used in today's detergents include sodium carbonate (soda ash), sodium bicarbonate (baking soda), sodium metasilicate, and sodium hydroxide. Phosphates such as sodium tripolyphosphate (STPP) have been used as builders in heavy-duty industrial detergents; however, due to the potential environmental effects of phosphates in detergents, there is a move away from using phosphate builders. The phosphate builders combine with hardness minerals to form a soluble complex which is removed with wash water. They also sequester dissolved iron and manganese which can interfere with detergency.

Sodium bicarbonate is non-hazardous, non-toxic, is neither corrosive nor caustic, and is biodegradable. It has a near-neutral pH of 8.2, and unlike chemical cleaning solvents, baking soda does not have handling concerns, or toxic fumes, and does not damage the skin.

Sodium carbonate (soda ash) generally softens through precipitation. Precipitated calcium and magnesium particles can build up on surfaces, especially clothing; therefore, it is not used in laundry detergents. However, it can be used in car cleaning compositions.

As used herein “foam stabilizer” controls the amount of flash foam in the cleaning composition. Sodium lauryl ether sulfate is added to increase the amount of flash foam. Amphoteric molecules such as sodium cocoamphopropionate are used for creating more creamy dense foam. For foam stability and viscosity building, an amide, betaine, or amine oxide can be used. Amine oxides, such as lauramine oxide and other amine oxides, act as foam enhancers. Betaines and sultaines (or sulfobetaines) can enhance foaming. Sugar also has an effect on foam formation. Sugar serves both as a builder and foam stabilizer. In embodiments, sucrose can serve to stabilize foaming, and thus can help enhance foaming.

As used herein “surfactant” is a surface-active agent that is a basic building block of all cleaning products. Surfactants alter the properties of water to enable it to clean. They lower the surface tension of water (makes water wetter). They also make water and oils compatible with each other through a process called emulsification.

As used herein, “anionic surfactants” are surfactants that carry a negatively charged head group. The most commonly used anionic surfactants are based on aliphatic carboxylic acids, which can be derived from naturally occurring animal and plant fats. Linear chain alkyl benzenesulfonate types are the most popularly used synthetic anionic surfactants.

As used herein, “amphoteric surfactants” refer to surfactants with both acidic and alkaline properties. Amphoteric surfactants have a dual charge on their hydrophilic end, both positive and negative. The dual charges cancel each other out creating a net charge of zero, referred to as zwitterionic. The pH of any given solution determines how the amphoteric surfactants work.

As used herein “chelating agent” refers to ‘sequestering agents’ or molecules capable of forming complexes with metal ions. In cleaning products, they are most commonly used to prevent soaps/detergents from reacting with the mineral deposits in hard water and forming soap scum. While not wishing to be bound by theory, the mechanism by which chelating agents work is by combining with certain metal ions to form a molecular complex that locks up or chelates the metal ion so that it no longer exhibits ionic properties. In hard water, calcium and magnesium ions are thus inactivated, and the water is effectively softened.

As used herein “fragrance source” refers to a source of fragrance that can be formulated into the vehicle cleaning formulation.

As used herein, “green note” is defined by the smell of green vegetation, such as a crumpled leaf, a cut stem, or fresh wet grass with dew. It is a facet that gives a lot of dynamism, cheerfulness, and naturalness to the perfume.

As used herein, “citrus note” is defined by the smell of a citrus tree, such as orange, both sweet and bitter, and lemons. Citrus notes are rather volatile and often used in the top opening notes to add freshness to a fragrance.

As used herein, a “dye” is a colorant, most typically water-based designed for use in the vehicle cleaning composition. Dyes are organic compounds which ionically bond to a substrate. Unlike pigments, they are transparent.

The present disclosure discloses vehicle cleaning compositions comprising:
(i) at least one builder and/or foam stabilizer;
(ii) at least one surfactant selected from the group consisting of anionic surfactants and amphoteric surfactants;
(iii) at least one chelating agent; and optionally:
(iv) a fragrance source; and/or
(v) a dye;
wherein, the compositions are in the form of a solid.

Surprisingly, the vehicle cleaning compositions described herein can clean a vehicle without damaging its exterior surface and its acrylic coating under normal and high temperatures and over time, for example, 85° C. for 15 mins, during and after washing. The compositions are also safe on external coatings such as wax, ceramic, and graphene. It is the specific combination of surfactants, builders, foam stabilizers, chelating agents, and pH that enables the compositions described herein to have these surprising features.

In embodiments, the builder and/or foam stabilizer is selected from the group consisting of sodium carbonate, sodium bicarbonate, and one or more sugars.

In embodiments, the one or more sugars are selected from the group consisting of monosaccharides, disaccharides, and polysaccharides.

Simple sugars, also called monosaccharides, include glucose, fructose, and galactose. Compound sugars, also called disaccharides or double sugars, are molecules made of two bonded monosaccharides; common examples are sucrose (glucose+fructose), lactose (glucose+galactose), and maltose (two molecules of glucose). White sugar is a refined form of sucrose.

In embodiments, the monosaccharide is selected from the group consisting of glucose, fructose, and galactose. In embodiments, the disaccharide is selected from the group consisting of sucrose, lactose, and maltose.

In embodiments, the anionic surfactant comprises an alkali metal salt or an ammonium salt. In embodiments, the alkali metal salt is selected from the group sodium C₈-C₂₂ alkyl sulfate, potassium C₈-C₂₂ alkyl sulfate, ammonium C₈-C₂₂ alkyl sulfate, sodium C₈-C₂₂ alkyl benzene sulfate, potassium C₈-C₂₂ alkyl benzene sulfate, ammonium C₈-C₂₂ alkyl benzene sulfate, sodium lauryl sulfate, sodium C₈-C₂₂ alkyloyl sarcosinate, and an α-olefin sulfonate of the formula

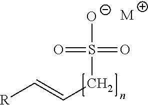

wherein R is an C₈-C₂₂ alkyl group, M⁺ is Na⁺ or K⁺ and n is 1 or 2.

The sodium C₈-C₂₂ alkyloyl sarcosinate is represented by the formula

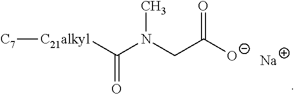

In embodiments, the amphoteric surfactant is selected from the group consisting of betaines, fatty alkyl imidazoline derivatives, and alkyl amine oxides.

Betaines are characterized by a fully quaternized nitrogen atom and do not exhibit anionic properties in alkaline solutions, which means that betaines are present only as zwitterions.

The fatty alkyl imidazoline derivatives are so designated because of the formation of an intermediate imidazoline structure during the synthesis of some of these surfactants. This group contains the real amphoteric surfactants that form cations in acidic solutions, anions in alkaline solutions, and ‘zwitterions’ in mid-pH range solutions. The mid-pH range (isoelectric range) in which the surfactant has a neutral charge is compound specific and depends on the alkalinity of the nitrogen atom and the acidity of the carboxylic group.

In embodiments, the betaine is an alkyl betaine of the formula

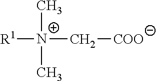

wherein R¹ is a C₆-C₂₂ alkyl group; or an alkylamidopropyl betaine of the formula

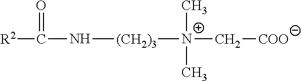

wherein R² is a C₈-C₂₂ alkyl group. A specific example of an alkylamidopropyl betaine is cocamidopropyl betaine (cocoamidopropyl betaine), having the structure:

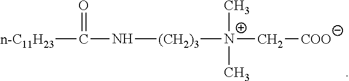

In embodiments, the fatty alkyl imidazoline derivative is an alkylamphodiacetate of the formula

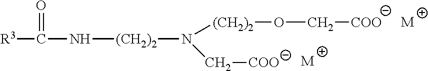

wherein R³ is a C₆-C₁₄ alkyl group, and M is sodium or potassium; an alkylamphodipropionate of the formula

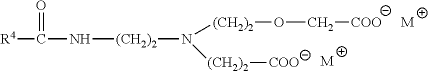

wherein R⁴ is a C₆-C₁₄ alkyl group, and M is sodium or potassium; or an alkyliminodipropionate of the formula

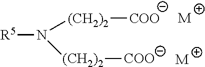

wherein R⁵ is a C₈-C₁₆ alkyl group, and M is sodium or potassium.

In embodiments, the alkylamphodiacetate is disodium or dipotassium lauroamphodiacetate; the alkylamphodipropionate is disodium or dipotassium lauroamphodipropionate; and the alkyliminodipropionate is sodium or potassium lauriminodipropionate.

In embodiments, the alkyl amine oxide has the formula

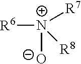

wherein R⁶ is a C₈-C₂₂ alkyl group, and R⁷ and R⁸ are independently a C₁-C₆ alkyl group. In embodiments, the alkyl amine oxide is lauryldimethylamine oxide, wherein R⁶ is C₁₂ alkyl, and R⁷ and R⁸ are each a methyl group.

The chelating agent of the disclosed vehicle cleaning compositions comprises at least one selected from the group consisting of citric acid, tetrasodium ethylenediaminetetraacetate, and tetrasodium glutamate diacetate. In embodiments, the chelating agent is citric acid. The citric acid can be provided in the form of a solid, either in crystalline or powder form.

In embodiments, in addition to acting as a chelating agent, citric acid also acts as an additive to control the pH of the vehicle cleaning composition. The carboxy groups of citric acid can bind and/or capture mono-, di-, and/or tri-cationic ions. By capturing an excess amount of ions, it can protect the vehicle surface from damage.

In embodiments, the fragrance source of the vehicle cleaning composition is a is either natural or synthetic, and/or is in a solid form, for example, the oil encapsulated in a coating such as a polymeric material, or a liquid form. In embodiments, the fragrance source comprises citrus and/or green notes to release fresh scents. In embodiments, the fragrance source is a fragrance oil. In embodiments, the fragrance source is Fragrance Porsche Glass 631300 (liquid).

In embodiments, the dye of the vehicle cleaning composition is in natural or synthetic dye and/or in solid or liquid form. In embodiments, the dye is X-3944 Chromatint Blue 3944 Liquid.

In embodiments, the vehicle cleaning composition comprises sodium carbonate, sodium C₁₀-C₁₆ alkyl benzene sulfonate, citric acid, fragrance source, and dye. Optionally, the fragrance source in the composition comprises Fragrance Porsche Glass 631300, and the dye in the composition comprises X-3944 Chromatint Blue 3944.

In embodiments, the vehicle cleaning composition comprises by total weight percent (%) of the composition:
(i) about 0.05% to about 50% of sodium carbonate;
(ii) about 5% to about 50% of sodium C₁₀-C₁₆ alkyl benzene sulfonate;
(iii) about 0.01% to about 40% citric acid
(iv) about 0.20% to about 3% of the fragrance source; and
(v) about 0.01% to about 0.5% of the dye.

In embodiments, in this composition, the citric acid and sodium carbonate are in the form of a powder, and the sodium C₁₀-C₁₆ alkyl benzene sulfonate is in granular form.

In embodiments, the vehicle cleaning composition comprises by total weight % of the composition:
(i) about 1% to about 45% of sodium carbonate;
(ii) about 8% to about 40% of sodium C₁₀-C₁₆ alkyl benzene sulfonate;
(iii) about 0.03% to about 30% citric acid
(iv) about 0.20% to about 2% of the fragrance source; and
(v) about 0.05% to about 0.4% of the dye;

In embodiments, in this composition, the citric acid and sodium carbonate are in the form of a powder, and the sodium C₁₀-C₁₆ alkyl benzene sulfonate is in granular form.

In embodiments, the vehicle cleaning composition comprises by total weight % of the composition:
(i) about 37% to about 38% of sodium carbonate;
(ii) about 24% to about 26% of sodium C₁₀-C₁₆ alkyl benzene sulfonate;
(iii) about 37% to about 38% of citric acid;
(iv) about 0.30% to about 0.40% of the fragrance source; and
(v) about 0.05% to about 0.15% of the dye.

In embodiments, in this composition, the citric acid and sodium carbonate are in the form of a powder, and the sodium C₁₀-C₁₆ alkyl benzene sulfonate is in granular form.

In embodiments, the vehicle cleaning composition comprises by total weight % of the composition:
(i) about 37.28% of sodium carbonate;
(ii) about 25.0% of sodium C₁₀-C₁₆ alkyl benzene sulfonate;
(iii) about 37.28% of citric acid;
(iv) about 0.35% of the fragrance source; and
(v) about 0.10% of the dye.

In embodiments, in this composition, the citric acid and sodium carbonate are in the form of a powder, and the sodium C₁₀-C₁₆ alkyl benzene sulfonate is in granular form.

In embodiments, the vehicle cleaning composition comprises sodium bicarbonate, sugar, sodium C₁₀-C₁₆ alkyl benzene sulfonate, sodium lauryl sulfate, citric acid, fragrance source, and dye. Optionally, the fragrance source in the composition comprises Fragrance Porsche Glass 631300, and the dye in the composition comprises X-3944 Chromatint Blue 3944.

In embodiments, the vehicle cleaning composition comprises by total weight % of the composition:
(i) about 0.05% to about 50% of sodium bicarbonate;
(ii) about 5% to about 50% of the sugar;
(iii) about 1% to about 30% of sodium C₁₀-C₁₆ alkyl benzene sulfonate;
(iv) about 5% to about 50% of sodium lauryl sulfate;
(v) about 0.05% to about 5% of citric acid;
(vi) about 0.10% to about 4% of the fragrance source; and
(vii) about 0.05% to about 0.40% of the dye.

In embodiments, in this composition, the citric acid, and sodium bicarbonate are in the form of a powder, and the sugar, the sodium C₁₀-C₁₆ alkyl benzene sulfonate, and the sodium lauryl sulfate are in granular form.

In embodiments, the vehicle cleaning composition comprises by total weight % of the composition:
(i) about 1% to about 45% of sodium bicarbonate;
(ii) about 8% to about 40% of the sugar;
(iii) about 2% to about 25% of sodium C₁₀-C₁₆ alkyl benzene sulfonate;
(iv) about 10% to about 40% of sodium lauryl sulfate;
(v) about 0.1% to about 4% of citric acid;
(vi) about 0.20% to about 3% of the fragrance source; and
(vii) about 0.1% to about 0.30% of the dye.

In embodiments, in this composition, the citric acid, and sodium bicarbonate are in the form of a powder, and the sugar, the sodium C₁₀-C₁₆ alkyl benzene sulfonate, and the sodium lauryl sulfate are in granular form.

In embodiments, the vehicle cleaning composition comprises by total weight % of the composition:
(i) about 33% to about 37% of sodium bicarbonate;
(ii) about 22% to about 26% of the sugar;
(iii) about 8% to about 12% by weight of sodium C₁₀-C₁₆ alkyl benzene sulfonate;
(iv) about 28% to about 32% of sodium lauryl sulfate;
(v) about 0.3% to about 0.7% of citric acid;
(vi) about 0.30-0.40% of the fragrance source; and
(vii) about 0.05-0.15% of the dye.

In embodiments, in this composition, the citric acid, and sodium bicarbonate are in the form of a powder, and the sugar, the sodium C₁₀-C₁₆ alkyl benzene sulfonate, and the sodium lauryl sulfate are in granular form.

In embodiments, the vehicle cleaning composition comprises by total weight % of the composition:
(i) about 35.0% of sodium bicarbonate;
(ii) about 24.05% of the sugar;
(iii) about 10% by weight of sodium C₁₀-C₁₆ alkyl benzene sulfonate;
(iv) about 30% of sodium lauryl sulfate;
(v) about 0.50% of citric acid;
(vi) about 0.35% of the fragrance source; and
(vii) about 0.10% of the dye.

In embodiments, in this composition, the citric acid, and sodium bicarbonate are in the form of a powder, and the sugar, the sodium C₁₀-C₁₆ alkyl benzene sulfonate, and the sodium lauryl sulfate are in granular form.

In embodiments, the vehicle composition comprises sodium bicarbonate, sugar, sodium C₁₀-C₁₆ alkyl benzene sulfonate, sodium lauryl sulfate, citric acid, fragrance source, and dye. Optionally, the fragrance source in the composition comprises Fragrance Porsche Glass 631300, and the dye in the composition comprises X-3944 Chromatint Blue 3944.

In embodiments, the vehicle cleaning composition comprises by total weight % of the composition:
(i) about 0.05% to about 50% of sodium bicarbonate;
(ii) about 5% to about 50% of the sugar;
(iii) about 1% to about 40% of sodium C₁₀-C₁₆ alkyl benzene sulfonate;
(iv) about 5% to about 40% of sodium lauryl sulfate;
(v) about 0.05% to about 5% of citric acid;
(vi) about 0.10% to about 4% of the fragrance source; and
(vii) about 0.05% to about 0.40% of the dye.

In embodiments, in this composition, the citric acid, and sodium bicarbonate are in the form of a powder, and the sugar, the sodium C₁₀-C₁₆ alkyl benzene sulfonate, and the sodium lauryl sulfate are in granular form.

In embodiments, the vehicle cleaning composition comprises by total weight % of the composition:
(i) about 1% to about 45% of sodium bicarbonate;
(ii) about 8% to about 40% of the sugar;
(iii) about 2% to about 35% of sodium C₁₀-C₁₆ alkyl benzene sulfonate;
(iv) about 2% to about 35% of sodium lauryl sulfate;
(v) about 0.1% to about 4% of citric acid;
(vi) about 0.20% to about 3% of the fragrance source; and
(vii) about 0.01% to about 0.30% of the dye.

In embodiments, in this composition, the citric acid, and sodium bicarbonate are in the form of a powder, and the sugar, the sodium C₁₀-C₁₆ alkyl benzene sulfonate, and the sodium lauryl sulfate are in granular form.

In embodiments, the vehicle cleaning composition comprises by total weight % of the composition:
(i) about 33% to about 37% of sodium bicarbonate;
(ii) about 22% to about 26% of the sugar;
(iii) about 18% to about 22% by weight of sodium C₁₀-C₁₆ alkyl benzene sulfonate;
(iv) about 18% to about 22% of sodium lauryl sulfate;
(v) about 0.3% to about 0.7% of citric acid;
(vi) about 0.30-0.40% of the fragrance source; and
(vii) about 0.05-0.15% of the dye.

In embodiments, in this composition, the citric acid, and sodium bicarbonate are in the form of a powder, and the sugar, the sodium C₁₀-C₁₆ alkyl benzene sulfonate, and the sodium lauryl sulfate are in granular form.

In embodiments, the vehicle cleaning composition comprises by total weight % of the composition:
(i) about 35% of sodium bicarbonate;
(ii) about 24.05% of the sugar;
(iii) about 20% by weight of sodium C₁₀-C₁₆ alkyl benzene sulfonate;
(iv) about 20% of sodium lauryl sulfate;
(v) about 0.5% of citric acid;
(vi) about 0.35% of the fragrance source; and
(vii) about 0.10% of the dye.

In embodiments, in this composition, the citric acid, and sodium bicarbonate are in the form of a powder, and the sugar, the sodium C₁₀-C₁₆ alkyl benzene sulfonate, and the sodium lauryl sulfate are in granular form.

In embodiments, the vehicle composition comprises sodium bicarbonate, sodium carbonate, sugar, sodium C₁₀-C₁₆ alkyl benzene sulfonate, sodium lauryl sulfate, citric acid, fragrance source, and dye. Optionally, the fragrance source in the composition comprises Fragrance Porsche Glass 631300, and the dye in the composition comprises X-3944 Chromatint Blue 3944.

In embodiments, the vehicle cleaning composition comprises by total weight % of the composition:
(i) about 0.05% to about 50% of sodium bicarbonate;
(ii) about 1% to about 30% of sodium carbonate
(iii) about 5% to about 50% of the sugar;
(iv) about 1% to about 40% of sodium C₁₀-C₁₆ alkyl benzene sulfonate;
(v) about 5% to about 45% of sodium lauryl sulfate;
(vi) about 0.05% to about 5% of citric acid;
(vii) about 0.10% to about 4% of the fragrance source; and
(viii) about 0.01% to about 0.40% of the dye.

In embodiments, in this composition, the citric acid, sodium carbonate, and sodium bicarbonate are in the form of a powder, and the sugar, the sodium C₁₀-C₁₆ alkyl benzene sulfonate, and the sodium lauryl sulfate are in granular form.

In embodiments, the vehicle cleaning composition comprises by total weight % of the composition:
(i) about 1% to about 45% of sodium bicarbonate;
(ii) about 2% to about 25% of sodium carbonate;
(iii) about 8% to about 40% of the sugar;
(iv) about 2% to about 35% of sodium C₁₀-C₁₆ alkyl benzene sulfonate;
(v) about 2% to about 40% of sodium lauryl sulfate;
(vi) about 0.1% to about 4% of citric acid;
(vii) about 0.20% to about 3% of the fragrance source; and
(viii) about 0.01% to about 0.30% of the dye.

In embodiments, in this composition, the citric acid, sodium carbonate, and sodium bicarbonate are in the form of a powder, and the sugar, the sodium C₁₀-C₁₆ alkyl benzene sulfonate, and the sodium lauryl sulfate are in granular form.

In embodiments, the vehicle cleaning composition comprises by total weight % of the composition:
(i) about 33% to about 37% of sodium bicarbonate;
(ii) about 8% to about 12% of sodium carbonate;
(iii) about 22% to about 26% of the sugar;
(iv) about 18% to about 22% by weight of sodium C₁₀-C₁₆ alkyl benzene sulfonate;
(v) about 28% to about 32% of sodium lauryl sulfate;
(vi) about 0.3% to about 0.7% of citric acid;
(vii) about 0.30-0.40% of the fragrance source; and
(viii) about 0.05-0.15% of the dye.

In embodiments, in this composition, the citric acid, sodium carbonate, and sodium bicarbonate are in the form of a powder, and the sugar, the sodium C₁₀-C₁₆ alkyl benzene sulfonate, and the sodium lauryl sulfate are in granular form.

In embodiments, the vehicle cleaning composition comprises by total weight % of the composition:
(i) about 35% of sodium bicarbonate;
(ii) about 10% of sodium carbonate;
(iii) about 24.05% of the sugar;
(iv) about 20% by weight of sodium C₁₀-C₁₆ alkyl benzene sulfonate;
(v) about 30% of sodium lauryl sulfate;
(vi) about 0.5% of citric acid;
(vii) about 0.35% of the fragrance source; and
(viii) about 0.10% of the dye.

In embodiments, in this composition, the citric acid, sodium carbonate, and sodium bicarbonate are in the form of a powder, and the sugar, the sodium C₁₀-C₁₆ alkyl benzene sulfonate, and the sodium lauryl sulfate are in granular form.

In embodiments, the vehicle composition comprises sodium bicarbonate, sugar, sodium C₁₀-C₁₆ alkyl benzene sulfonate, citric acid, fragrance source, and dye. Optionally, the fragrance source in the composition comprises Fragrance Porsche Glass 631300, and the dye in the composition comprises X-3944 Chromatint Blue 3944.

In embodiments, the vehicle cleaning composition comprises by total weight % of the composition:
(i) about 1% to about 40% of sodium bicarbonate;
(ii) about 5% to about 40% of the sugar;
(iii) about 1% to about 70% of sodium C₁₀-C₁₆ alkyl benzene sulfonate;
(iv) about 0.01% to about 3% of citric acid;
(v) about 0.10% to about 4% of the fragrance source; and
(vi) about 0.01% to about 0.50% of the dye.

In embodiments, in this composition, the citric acid, and sodium bicarbonate are in the form of a powder, and the sugar, and sodium C₁₀-C₁₆ alkyl benzene sulfonate are in granular form. In embodiments, the vehicle cleaning composition comprises by total weight % of the composition:
(i) about 5% to about 35% of sodium bicarbonate;
(ii) about 5% to about 35% of the sugar;
(iii) about 10% to about 60% of sodium C₁₀-C₁₆ alkyl benzene sulfonate;
(iv) about 0.01% to about 2% of citric acid;
(v) about 0.20% to about 2% of the fragrance source; and
(vi) about 0.05% to about 0.40% of the dye.

In embodiments, in this composition, the citric acid, and sodium bicarbonate are in the form of a powder, and the sugar, and sodium C₁₀-C₁₆ alkyl benzene sulfonate are in granular form.

In embodiments, the vehicle cleaning composition comprises by total weight % of the composition:
(i) about 23% to about 27% of sodium bicarbonate;
(ii) about 22% to about 27% of the sugar;
(iii) about 48% to about 52% of sodium C₁₀-C₁₆ alkyl benzene sulfonate;
(iv) about 0.01% to about 0.05% of citric acid;
(v) about 0.30-0.40% of the fragrance source; and
(vi) about 0.05-0.15% of the dye.

In embodiments, in this composition, the citric acid, and sodium bicarbonate are in the form of a powder, and the sugar, and sodium C₁₀-C₁₆ alkyl benzene sulfonate are in granular form.

In embodiments, the vehicle cleaning composition comprises by total weight % of the composition:
(i) about 25% of sodium bicarbonate;
(ii) about 24.52% of the sugar;
(iii) about 50% of sodium C₁₀-C₁₆ alkyl benzene sulfonate;
(iv) about 0.03% of citric acid;
(v) about 0.35% of the fragrance source; and
(vi) about 0.10% of the dye.

In embodiments, in this composition, the citric acid, and sodium bicarbonate are in the form of a powder, and the sugar, and sodium C₁₀-C₁₆ alkyl benzene sulfonate are in granular form. The present disclosure discloses vehicle cleaning compositions comprising:
(i) at least one builder and/or foam stabilizer, and optionally wherein the at least one builder and/or foam stabilizer is selected from the group consisting of one or more sugars, sodium carbonate, and sodium bicarbonate;
(ii) at least one surfactant selected from the group consisting of anionic surfactants and amphoteric surfactants;
(iii) at least one hydrotropic additive; and optionally:
(iv) a fragrance source; and/or
(v) a dye;
wherein, the composition is in the form of a solid, and wherein the builder, foam stabilizer, amphoteric and anionic surfactants, sugars, fragrance source, and dye are as described herein.

In embodiments, the anionic surfactants are selected from the group consisting of sodium C₈-C₂₂ alkyl benzene sulfonate and sodium C₈-C₂₂ alkyl sulfate. An example of sodium C₈-C₂₂ alkyl benzene sulfonate includes sodium C₁₀-C₁₆ alkyl benzene sulfonate, and an example of sodium C₈-C₂₂ alkyl sulfate includes sodium lauryl sulfate.

In embodiments, in this composition, the hydrotropic additive is selected from the group consisting of sodium xylene sulfonate, urea, a tosylate (having a toluenesulfonate group), and sodium cumene sulfonate. Tosylate compounds can be represented by the formula

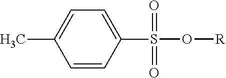

wherein R is a C₁-C₆ alkyl group.

In embodiments, the vehicle composition comprises sugar, sodium C₁₀-C₁₆ alkyl benzene sulfonate, sodium lauryl sulfate, sodium xylene sulfonate, fragrance source, and dye. Optionally, the fragrance source in the composition comprises Fragrance Porsche Glass 631300, and the dye in the composition comprises X-3944 Chromatint Blue 3944.

In embodiments, in this composition, the composition comprises by total weight % of the composition:
(i) about 5% to about 25% of the sugar;
(ii) about 10% to about 60% of sodium C₁₀-C₁₆ alkyl benzene sulfonate;
(iii) about 5% to about 40% sodium lauryl sulfate;
(iv) about 1% to about 10% of sodium xylene sulfonate;
(v) about 0.10% to about 4% of the fragrance source; and
(vi) about 0.01% to about 0.50% of the dye.

In embodiments, in this composition, the sugar, sodium C₁₀-C₁₆ alkyl benzene sulfonate, and sodium lauryl sulfate are in granular form.

In embodiments, in this composition, the composition comprises by total weight % of the composition:
(i) about 5% to about 25% of the sugar;
(ii) about 20% to about 55% of sodium C₁₀-C₁₆ alkyl benzene sulfonate;
(iii) about 2% to about 30% sodium lauryl sulfate;
(iv) about 10% to about 40% of sodium xylene sulfonate;
(v) about 0.2% to about 3% of the fragrance source; and
(vi) about 0.05% to about 0.4% of the dye.

In embodiments, in this composition, the sugar, sodium C₁₀-C₁₆ alkyl benzene sulfonate, and sodium lauryl sulfate are in granular form.

In embodiments, in this composition, the composition comprises by total weight % of the composition:
(i) about 22% to about 27% of the sugar;
(ii) about 48% to about 52% of sodium C₁₀-C₁₆ alkyl benzene sulfonate;
(iii) about 18% to about 22% sodium lauryl sulfate;
(iv) about 3% to about 7% of sodium xylene sulfonate;
(v) about 0.3% to about 0.4% of the fragrance source; and
(vi) about 0.05% to about 0.15% of the dye.

In embodiments, in this composition, the sugar, sodium C₁₀-C₁₆ alkyl benzene sulfonate, and sodium lauryl sulfate are in granular form.

In embodiments, in this composition, the composition comprises by total weight % of the composition:
(i) about 24.55% of the sugar;
(ii) about 50% of sodium C₁₀-C₁₆ alkyl benzene sulfonate;
(iii) about 20% sodium lauryl sulfate;
(iv) about 5% of sodium xylene sulfonate;
(v) about 0.35% of the fragrance source; and
(vi) about 0.10% of the dye.

In embodiments, in this composition, the sugar, sodium C₁₀-C₁₆ alkyl benzene sulfonate, and sodium lauryl sulfate are in granular form.

In embodiments, any of the disclosed vehicle cleaning compositions are in the form of a powder or a compression-molded tablet.

In embodiments, any of the disclosed vehicle cleaning compositions are more than 90% (>90%) soluble in water.

In embodiments, any of the disclosed vehicle cleaning compositions have a pH of about 5 to about 9 in water.

In embodiments, any of the disclosed vehicle cleaning compositions dissolve in water within about 1 to about 5 minutes at about 50° F. to about 90° F. with or without agitation.

In embodiments, any of the disclosed vehicle cleaning compositions have the capability to create effervescence or gas bubbles to enhance quick dissolution in water.

The present disclosure also discloses a vehicle wash pack comprising a unit dose or multiple doses of any of the vehicle cleaning compositions disclosed herein. In embodiments, the unit dose is between about 5 grams and about 50 grams (or 5-10 grams, 5-15 grams, 5-20 grams, 5-25 grams, 5 to 30 grams, or 5-40 grams) of the solid composition. As used herein, the term “wash pack” can include a “wash pod”. The vehicle cleaning compositions described herein can be formed in any shape, for example, round, rectangular, square, or star-shaped. In embodiments, the shapes are round, square, or rectangular.

In embodiments, the unit dose or multiple doses of the composition present in the wash pack can be sized to wash a car, a pick-up truck, or a minivan.

In embodiments, the vehicle wash pack as disclosed further comprises a water-soluble hygroscopic polymeric covering enclosing the composition. The polymeric film does not cause any issues such as film breakage, discoloration, coloration, or longer dissolution time of greater than 5 minutes at 50° F. resulting from cleaning composition-polymeric film incompatibility. In embodiments, the polymeric covering comprises a polyvinyl alcohol (PVA) film.

The vehicle cleaning compositions described herein can be prepared by adding each of the components of a composition to a container and mixing the components to form a composition. The composition can also be prepared by adding each of the components at the same time or one by one to the container. In embodiments, the fragrance source and the dye are added last. In embodiments, the fragrance source and dye are added and mixed into the composition after all the other components have been mixed.

The method of preparing the vehicle cleaning compositions can further include packing or placing the vehicle clearing composition into a wash pack or a pod described herein. As described herein, the wash pack or pod can comprise a water-soluble hygroscopic polymeric covering for enclosing the composition. In embodiments, the covering comprises a PVA film.

The present disclosure also describes a process for washing the surface of a vehicle comprising: placing any of the vehicle cleaning compositions described herein, or the vehicle wash pack described herein into a container; adding water to said container to dissolve the composition or the wash pack with or without agitation, to prepare a solution for washing the surface of the vehicle; and applying the solution to the surface of the vehicle.

The container can be any suitable container, such as a pail, bucket, or chamber in a power washing equipment. Water can be added to the container through a hose operating at municipal water supply pressure. In embodiments, water exiting the hose provides the agitation for dissolving the composition.

In embodiments, while the polymeric film must remain intact without weakening, for storage of the vehicle wash composition until it is used, the film should dissolve quickly when water is added. Furthermore, the vehicle cleaning composition should generate foam, as the consumer would expect from any vehicle cleaning composition. These functions would be expected without a film residue left behind by the cleaning composition or the polymeric film that would compromise the shine quality imparted to the vehicle exterior.

Water temperature is an important contributor to the dissolution time of the encapsulation film of the vehicle wash pack. The time of dissolution of the polymeric film or skin is much faster at temperatures greater than 20° C. compared to temperatures below 20° C. Warm or hot water works very well, while cool water is slower but acceptable. Ice cold water is too slow and the container fills with water before permeation of the vehicle wash pack occurs. Once the container is full, the lack of agitation will not produce any foam absent mechanical agitation.

The surface of the vehicle to which the cleaning composition is applied can comprise the main body panels of the vehicle, the windshield and rear window glasses, the tires, the wheels, and/or the side view mirrors.

As will be understood by one of ordinary skill in the art, each embodiment disclosed herein can comprise, consist essentially of, or consist of its particular stated element, step, ingredient, or component. Thus, the terms “include” or “including” should be interpreted to recite: “comprise, consist of, or consist essentially of.” As used herein, the transition term “comprise” or “comprises” means includes, but is not limited to, and allows for the inclusion of unspecified elements, steps, ingredients, or components, even in major amounts. The transitional phrase “consisting of” excludes any element, step, ingredient, or component not specified. The transition phrase “consisting essentially of” limits the scope of the embodiment to the specified elements, steps, ingredients, or components and to those that do not materially affect the embodiment. As used herein, a material effect would cause a statistically significant difference in the performance of the composition.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. When further clarity is required, the term “about” has the meaning reasonably ascribed to it by a person skilled in the art when used in conjunction with a stated numerical value or range, i.e. denoting somewhat more or somewhat less than the stated value or range, to within a range of ±20% of the stated value; ±19% of the stated value; ±18% of the stated value; ±17% of the stated value; ±16% of the stated value; ±15% of the stated value; ±14% of the stated value; ±13% of the stated value; ±12% of the stated value; ±11% of the stated value; ±10% of the stated value; ±9% of the stated value; ±8% of the stated value; ±7% of the stated value; ±6% of the stated value; ±5% of the stated value; ±4% of the stated value; ±3% of the stated value; ±2% of the stated value; or ±1% of the stated value.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the disclosure (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the disclosure and does not pose a limitation on the scope of the disclosure otherwise claimed. No language in the specification should be construed as indicating any non-claimed element essential to the practice of the disclosure.

Groupings of alternative elements or embodiments of the disclosure disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this disclosure are described herein, including the best mode known to the inventors for carrying out the disclosure. Of course, variations on these described embodiments will become apparent to those of ordinary skill in the art upon reading the foregoing description. The inventor expects skilled artisans to employ such variations as appropriate, and the inventors intend for the disclosure to be practiced otherwise than specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

Furthermore, numerous references have been made to patents, printed publications, journal articles, and other written text throughout this specification (referenced materials herein). Each of the referenced materials is individually incorporated herein by reference in their entirety for their referenced teaching.

In closing, it is to be understood that the embodiments of the disclosure disclosed herein are illustrative of the principles of the present disclosure. Other modifications that may be employed are within the scope of the disclosure. Thus, by way of example, but not of limitation, alternative configurations of the present disclosure may be utilized in accordance with the teachings herein. Accordingly, the present disclosure is not limited to that precisely as shown and described.

The particulars shown herein are by way of example and for purposes of illustrative discussion of the preferred embodiments of the present disclosure only and are presented in the cause of providing what is believed to be the most useful and readily understood description of the principles and conceptual aspects of various embodiments of the disclosure. In this regard, no attempt is made to show structural details of the disclosure in more detail than is necessary for the fundamental understanding of the disclosure, the description taken with the drawings and/or examples making apparent to those skilled in the art how the several forms of the disclosure may be embodied in practice.

Definitions and explanations used in the present disclosure are meant and intended to be controlling in any future construction unless clearly and unambiguously modified in the examples or when application of the meaning renders any construction meaningless or essentially meaningless. In cases where the construction of the term would render it meaningless or essentially meaningless, the definition should be taken from Webster's Dictionary, 3rd Edition, or a dictionary known to those of ordinary skill in the art, such as the Oxford Dictionary of Biochemistry and Molecular Biology (Ed. Anthony Smith, Oxford University Press, Oxford, 2004).

The Exemplary Embodiments and Examples below are included to demonstrate particular embodiments of the disclosure. Those of ordinary skill in the art should recognize in light of the present disclosure that many changes can be made to the specific embodiments disclosed herein and still obtain a like or similar result without departing from the spirit and scope of the disclosure.

### EXEMPLARY EMBODIMENTS

The following are exemplary embodiments.

1. A vehicle cleaning composition comprising:
(i) at least one builder and/or foam stabilizer;
(ii) at least one surfactant selected from the group consisting of anionic surfactant and amphoteric surfactant; and
(iii) at least one chelating agent;
and optionally:
(iv) a fragrance source; and/or
(v) a dye;
wherein, the composition is in the form of a solid.

2. The vehicle cleaning composition of embodiment 1, wherein the builder and/or foam stabilizer is selected from the group consisting of sodium carbonate, sodium bicarbonate, and one or more sugars.

3. The vehicle cleaning composition of embodiment 2, wherein the sugar is selected from the group consisting of monosaccharides, disaccharides, and polysaccharides.

4. The vehicle cleaning composition of embodiment 3, wherein the monosaccharide is selected from the group consisting of glucose, fructose, and galactose.

5. The vehicle cleaning composition of embodiment 3, wherein the disaccharide is selected from the group consisting of sucrose, lactose, and maltose.

6. The vehicle cleaning composition of any one of embodiments 1-5, wherein the anionic surfactant comprises an alkali metal salt or an ammonium salt.

7. The vehicle cleaning composition of embodiment 6, wherein the alkali metal salt is selected from the group consisting of sodium C₈-C₂₂ alkyl sulfate, potassium C₈-C₂₂ alkyl sulfate, ammonium C₈-C₂₂ alkyl sulfate, sodium C₈-C₂₂ alkyl benzene sulfate, potassium C₈-C₂₂ alkyl benzene sulfate, ammonium C₈-C₂₂ alkyl benzene sulfate, sodium lauryl sulfate, sodium C₈-C₂₂ alkyl sarcosinate, and an α-olefin sulfonate of the formula

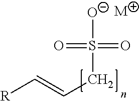

wherein R is an C₈-C₂₂ alkyl group, M⁺ is Na⁺ or K⁺ and n is 1 or 2.

8. The vehicle cleaning composition of any one of embodiments 1-7, wherein the amphoteric surfactant is selected from the group consisting of betaines, fatty alkyl imidazoline derivatives, and alkyl amine oxides.

9. The vehicle cleaning composition of embodiment 8, wherein the betaine is: (i) an alkyl betaine of the formula

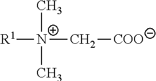

wherein R¹ is a C₆-C₂₂ alkyl group;
or
(ii) an alkylamidopropyl betaine of the formula

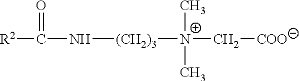

wherein R² is a C₆-C₂₂ alkyl group.

10. The vehicle cleaning composition of embodiment 8, wherein the fatty alkyl imidazoline derivative is:
(i) an alkylamphodiacetate of the formula

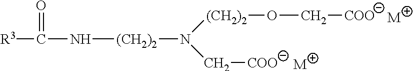

wherein R³ is a C₆-C₁₄ alkyl group, and M is sodium or potassium;
(ii) an alkylamphodipropionate of the formula

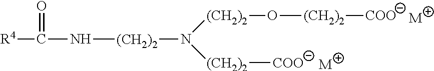

wherein R⁴ is a C₆-C₁₄ alkyl group, and M is sodium or potassium;
or
(iii) an alkyliminodipropionate of the formula

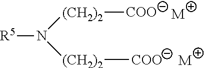

wherein R⁵ is a C₈-C₁₈ alkyl group, and M is sodium or potassium.

11. The vehicle cleaning composition of embodiment 10, wherein the alkylamphodiacetate is disodium or dipotassium lauroamphodiacetate, wherein the alkylamphodipropionate is disodium or dipotassium lauroamphodipropionate, and wherein the alkyliminodipropionate is sodium or potassium alkyliminodipropionate.

12. The vehicle cleaning composition of embodiment 8, wherein the alkyl amine oxide has the formula

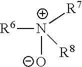

wherein R⁶ is a C₈-C₂₂ alkyl group, and R⁷ and R⁸ are independently a C₁-C₆ alkyl group.

13. The vehicle cleaning composition of embodiment 12, wherein R⁶ is C₁₂ alkyl, and R⁷ and R⁸ are each methyl, the alkyl amine oxide being lauryldimethylamine oxide.

14. The vehicle cleaning composition of any one of embodiments 1-13, wherein the chelating agent comprises at least one selected from the group consisting of citric acid, tetrasodium ethylenediaminetetraacetate, and tetrasodium glutamate diacetate.

15. The vehicle cleaning composition of any one of embodiments 1-14, wherein the fragrance source is natural or synthetic, and/or in a solid or a liquid form.

16. The vehicle cleaning composition of embodiment 14, wherein the fragrance oil comprises citrus and/or green notes in the fragrance to release fresh scents.

17. The vehicle cleaning composition of any one of embodiments 1-15, wherein the dye is a natural or synthetic dye and/or is in the form of a solid or liquid.

18. The vehicle cleaning composition of any one of embodiments 1-17, wherein the composition comprises, sodium carbonate, sodium C₁₀-C₁₆ alkyl benzene sulfonate, citric acid, fragrance source, and dye.

19. The vehicle cleaning composition of any one of embodiments 1-18, wherein the composition comprises by total weight % of the composition:
(i) about 0.05% to about 50% of sodium carbonate;
(ii) about 5% to about 50% of sodium C₁₀-C₁₆ alkyl benzene sulfonate; (iii) about 0.01% to about 40% citric acid;
(iv) about 0.20% to about 3% of the fragrance source; and
(v) about 0.01% to about 0.5% of the dye.

20. The vehicle cleaning composition of any one of embodiments 1-19, wherein the composition comprises by total weight % of the composition:
(i) about 1% to about 45% of sodium carbonate;
(ii) about 8% to about 40% of sodium C₁₀-C₁₆ alkyl benzene sulfonate;
(iii) about 0.03% to about 30% citric acid;
(iv) about 0.20% to about 2% of the fragrance source; and
(v) about 0.05% to about 0.4% of the dye;
21. The vehicle cleaning composition of any one of embodiments 1-20, wherein the composition comprises by total weight % of the composition:
(i) about 37-38% of sodium carbonate;
(ii) about 24-26% of sodium C₁₀-C₁₆ alkyl benzene sulfonate;
(iii) about 37-38% of citric acid;
(iv) about 0.30-0.40% of the fragrance source; and
(iv) about 0.05-0.15% of the dye.

22. The vehicle cleaning composition of any one of embodiments 18-21, wherein the citric acid and sodium carbonate are in the form of a powder, and wherein the sodium C₁₀-C₁₆ alkyl benzene sulfonate is in granular form.

23. The vehicle cleaning composition of any one of embodiments 1-17, wherein the composition comprises sodium bicarbonate, sugar, sodium C₁₀-C₁₆ alkyl benzene sulfonate, sodium lauryl sulfate, citric acid, fragrance source, and dye.

24. The vehicle cleaning composition of any one of embodiments 1-17 or 23, wherein the composition comprises by total weight % of the composition:
(i) about 0.05% to about 50% of sodium bicarbonate;
(ii) about 5% to about 50% of the sugar;
(iii) about 1% to about 30% of sodium C₁₀-C₁₆ alkyl benzene sulfonate;
(iv) about 5% to about 50% of sodium lauryl sulfate;
(v) about 0.05% to about 5% of citric acid;
(vi) about 0.10% to about 4% of the fragrance source; and
(vii) about 0.05% to about 0.40% of the dye.

25. The vehicle cleaning composition of any one of embodiments 1-17, 23, or 24, wherein the composition comprises by total weight % of the composition:
(i) about 1% to about 45% of sodium bicarbonate;
(ii) about 8% to about 40% of the sugar;
(iii) about 2% to about 25% of sodium C₁₀-C₁₆ alkyl benzene sulfonate;
(iv) about 10% to about 40% of sodium lauryl sulfate;
(v) about 0.1% to about 4% of citric acid;
(vi) about 0.20% to about 3% of the fragrance source; and
(vii) about 0.1% to about 0.30% of the dye.

26. The vehicle cleaning composition of any one of embodiments 1-17, or 23-25, wherein the composition comprises by total weight % of the composition:
(i) about 33% to about 37% of sodium bicarbonate;
(ii) about 22% to about 26% of the sugar;
(iii) about 8% to about 12% by weight of sodium C₁₀-C₁₆ alkyl benzene sulfonate;
(iv) about 28% to about 32% of sodium lauryl sulfate;
(v) about 0.3% to about 0.7% of citric acid;
(vi) about 0.30-0.40% of the fragrance source; and
(vii) about 0.05-0.15% of the dye.

27. The vehicle cleaning composition of any one of embodiments 23-26, wherein the citric acid and sodium bicarbonate are in the form of a powder, and wherein the sugar, the sodium C₁₀-C₁₆ alkyl benzene sulfonate, and the sodium lauryl sulfate are in granular form.

28. The vehicle cleaning composition of any one of embodiments 1-17, wherein the composition comprises sodium bicarbonate, sugar, C₁₀-C₁₆ alkyl benzene sulfonate, sodium lauryl sulfate, citric acid, fragrance source, and dye.

29. The vehicle cleaning composition of any one of embodiments 1-17 or 28, wherein the composition comprises by total weight % of the composition:
(i) about 0.05% to about 50% of sodium bicarbonate;
(ii) about 5% to about 50% of the sugar;
(iii) about 1% to about 40% of sodium C₁₀-C₁₆ alkyl benzene sulfonate;
(iv) about 5% to about 40% of sodium lauryl sulfate;
(v) about 0.05% to about 5% of citric acid;
(vi) about 0.10% to about 4% of the fragrance source; and
(vii) about 0.05% to about 0.40% of the dye.

30. The vehicle cleaning composition of any one of embodiments 1-17, 28, or 29, wherein the composition comprises by total weight % of the composition:
(i) about 1% to about 45% of sodium bicarbonate;
(ii) about 8% to about 40% of the sugar;
(iii) about 2% to about 35% of sodium C₁₀-C₁₆ alkyl benzene sulfonate;
(iv) about 2% to about 35% of sodium lauryl sulfate;
(v) about 0.1% to about 4% of citric acid;
(vi) about 0.20% to about 3% of the fragrance source; and
(vii) about 0.01% to about 0.30% of the dye.

31. The vehicle cleaning composition of any one of embodiments 1-17, or 28-30, wherein the composition comprises by total weight % of the composition:
(i) about 33% to about 37% of sodium bicarbonate;
(ii) about 22% to about 26% of the sugar;
(iii) about 18% to about 22% by weight of sodium C₁₀-C₁₆ alkyl benzene sulfonate;
(iv) about 18% to about 22% of sodium lauryl sulfate;
(v) about 0.3% to about 0.7% of citric acid;
(vi) about 0.30 to about 0.40% of the fragrance source; and
(vii) about 0.05 to about 0.15% of the dye.

32. The vehicle cleaning composition of any one of embodiments 28-31, wherein the citric acid and sodium bicarbonate are in the form of a powder, and wherein the sugar, the sodium C₁₀-C₁₆ alkyl benzene sulfonate, and the sodium lauryl sulfate are in granular form.

33. The vehicle cleaning composition of any one of embodiments 1-17, wherein the composition comprises sodium bicarbonate, sugar, sodium C₁₀-C₁₆ alkyl benzene sulfonate, sodium lauryl sulfate; citric acid, fragrance source, and dye.

34. The vehicle cleaning composition of any one of embodiments 1-17 or 33, wherein the composition comprises by total weight % of the composition:
(i) about 0.05% to about 50% of sodium bicarbonate;
(ii) about 5% to about 40% of the sugar;
(iii) about 1% to about 45% of sodium C₁₀-C₁₆ alkyl benzene sulfonate;
(iv) about 1% to about 20% of sodium lauryl sulfate;
(v) about 0.05% to about 5% of citric acid;
(vi) about 0.10% to about 4% of the fragrance source; and
(vii) about 0.01% to about 0.40% of the dye.

35. The vehicle cleaning composition of any one of embodiments 1-17, 33, or 34, wherein the composition comprises by total weight % of the composition:
(i) about 1% to about 40% of sodium bicarbonate;
(ii) about 8% to about 35% of the sugar;
(iii) about 2% to about 40% of sodium C₁₀-C₁₆ alkyl benzene sulfonate;
(iv) about 2% to about 15% of sodium lauryl sulfate;
(v) about 0.1% to about 4% of citric acid;
(vi) about 0.20% to about 3% of the fragrance source; and
(vii) about 0.01% to about 0.30% of the dye.

36. The vehicle cleaning composition of any one of embodiments 1-17, or 33-35, wherein the composition comprises by total weight % of the composition:
(i) about 33% to about 37% of sodium bicarbonate;
(ii) about 22% to about 26% of the sugar;
(iii) about 28% to about 32% by weight of sodium C₁₀-C₁₆ alkyl benzene sulfonate;
(iv) about 8% to about 12% of sodium lauryl sulfate;
(v) about 0.3% to about 0.7% of citric acid;
(vi) about 0.30% to about 0.40% of the fragrance source; and
(vii) about 0.05% to about 0.15% of the dye.

37. The vehicle cleaning composition of any one of embodiments 33-36, wherein the citric acid, and sodium bicarbonate are in the form of a powder, and wherein the sugar, sodium C₁₀-C₁₆ alkyl benzene sulfonate, and sodium lauryl sulfate are in granular form.

38. The vehicle cleaning composition of any one of embodiments 1-17, wherein the composition comprises sodium bicarbonate, sugar, sodium C₁₀-C₁₆ alkyl benzene sulfonate, citric acid, fragrance source, and dye.

39. The vehicle cleaning composition of any one of embodiments 1-17 or 38, wherein the composition comprises by total weight % of the composition:
(i) about 1% to about 40% of sodium bicarbonate;
(ii) about 5% to about 40% of the sugar;
(iii) about 1% to about 70% of sodium C₁₀-C₁₆ alkyl benzene sulfonate;
(iv) about 0.01% to about 3% of citric acid;
(v) about 0.10% to about 4% of the fragrance source; and
(vi) about 0.01% to about 0.50% of the dye.

40. The vehicle cleaning composition of any one of embodiments 1-17, 38, or 39, wherein the composition comprises by total weight % of the composition:
(i) about 5% to about 35% of sodium bicarbonate;
(ii) about 5% to about 35% of the sugar;
(iii) about 10% to about 60% of sodium C₁₀-C₁₆ alkyl benzene sulfonate;
(iv) about 0.01% to about 2% of citric acid;
(v) about 0.20% to about 2% of the fragrance source; and
(vi) about 0.05% to about 0.40% of the dye.

41. The vehicle cleaning composition of any one of embodiments 1-17 or 38-40, wherein the composition comprises by total weight % of the composition:
(i) about 23% to about 27% of sodium bicarbonate;
(ii) about 22% to about 27% of the sugar;
(iii) about 48% to about 52% of sodium C₁₀-C₁₆ alkyl benzene sulfonate;
(iv) about 0.01% to about 0.05% of citric acid;
(v) about 0.30% to about 0.40% of the fragrance source; and
(vi) about 0.05% to about 0.15% of the dye.

42. The vehicle cleaning composition of any one of embodiments 38-40, wherein the citric acid and sodium bicarbonate are in the form of a powder, and wherein the sugar and sodium C₁₀-C₁₆ alkyl benzene sulfonate are in granular form.

43. A vehicle cleaning composition comprising:
(i) at least one builder and/or foam stabilizer, and optionally wherein the at least one builder and/or foam stabilizer is selected from the group consisting of one or more sugars, sodium carbonate, and sodium bicarbonate;
(ii) at least one surfactant, and optionally wherein the at least one surfactant is selected from the group consisting of anionic surfactants and amphoteric surfactants, and optionally wherein the anionic surfactant is selected from the group consisting of sodium C₈-C₂₂ alkyl benzene sulfonate and sodium C₈-C₂₂ alkyl sulfate; and
(iii) at least one hydrotropic additive;
   and optionally:
(iv) a fragrance source; and/or
(v) a dye;
wherein, the composition is in the form of a solid.

44. The vehicle cleaning composition of embodiment 43, wherein the sodium C₈-C₂₂ alkyl benzene sulfonate is sodium C₁₀-C₁₆ alkyl benzene sulfonate, and wherein the sodium C₈-C₂₂ alkyl sulfate is sodium lauryl sulfate.

45. The vehicle cleaning composition of embodiment 43 or 44, wherein the hydrotropic additive is selected from the group consisting of sodium xylene sulfonate, urea, a tosylate, and sodium cumene sulfonate.

46. The vehicle cleaning composition of any one of embodiments 43-45, wherein the composition comprises sugar, sodium C₁₀-C₁₆ alkyl benzene sulfonate, sodium lauryl sulfate, sodium xylene sulfonate, fragrance source, and dye.

47. The vehicle cleaning composition of any one of embodiments 43-46, wherein the composition comprises by total weight % of the composition:
(i) about 5% to about 25% of the sugar;
(ii) about 10% to about 60% of sodium C₁₀-C₁₆ alkyl benzene sulfonate;
(iii) about 5% to about 40% sodium lauryl sulfate;
(iv) about 1% to about 10% of sodium xylene sulfonate;
(v) about 0.10% to about 4% of the fragrance source; and
(vi) about 0.01% to about 0.50% of the dye.

48. The vehicle cleaning composition of any one of embodiments 43-47, wherein the composition comprises by total weight % of the composition:
(i) about 5% to about 25% of the sugar;
(ii) about 20% to about 55% of sodium C₁₀-C₁₆ alkyl benzene sulfonate;
(iii) about 2% to about 30% sodium lauryl sulfate;
(iv) about 10% to about 40% of sodium xylene sulfonate;
(v) about 0.2% to about 3% of the fragrance source; and
(vi) about 0.05% to about 0.4% of the dye.

49. The vehicle cleaning composition of any one of embodiments 43-48, wherein the composition comprises by total weight % of the composition:
(i) about 22% to about 27% of the sugar;
(ii) about 48% to about 52% of sodium C₁₀-C₁₆ alkyl benzene sulfonate;
(iii) about 18% to about 22% sodium lauryl sulfate;
(iv) about 3% to about 7% of sodium xylene sulfonate;
(v) about 0.3% to about 0.4% of the fragrance source; and
(vi) about 0.05% to about 0.15% of the dye.

50. The vehicle cleaning composition of any one of embodiments 43-49, wherein the sugar, sodium C₁₀-C₁₆ alkyl benzene sulfonate, and sodium lauryl sulfate are in granular form.

51. The vehicle cleaning composition of any one of embodiments 1-50, wherein the composition is in the form of a powder or a compression-molded tablet.

52. The vehicle cleaning composition of any one of embodiments 1-51, wherein the composition is more than 90% (>90%) soluble in water.

53. The vehicle cleaning composition of any one of embodiments 1-52, wherein the composition has a pH of about 5 to about 9 in water.

54. The vehicle cleaning composition of any one of embodiments 1-53, wherein the composition dissolves in water within about 1 to about 5 minutes at about 50° F. to about 90° F. with or without agitation.

55. The vehicle cleaning composition of any one of embodiments 1-54, wherein the composition creates effervescence or gas bubbles to enhance quick dissolution in water.

56. A vehicle wash pack comprising a unit dose or multiple doses of the composition of any one of embodiments 1-55.

57. The vehicle wash pack of embodiment 56, wherein the unit dose is between about 5 grams and about 50 grams of the solid composition.

58. The vehicle wash pack of embodiment 56 or 57, wherein the unit or multiples doses of the composition is/are sized to wash a car, pick-up truck, or minivan.

59. The vehicle wash pack of any one of embodiments 56-58, further comprising a water-soluble hygroscopic polymeric covering enclosing the composition.

60. The vehicle wash pack of embodiment 59, wherein the polymeric covering comprises a polyvinyl alcohol (PVA) film.

61. A process for washing the surface of a vehicle comprising:
placing the vehicle cleaning composition of any one of embodiments 1-55, or the vehicle wash pack of any one of Embodiments 56-60 into a container; and
adding water to said container to dissolve the composition or the wash pack with or without agitation, to prepare a solution for washing the surface of the vehicle; and
applying the solution to the surface of the vehicle.

62. The process of embodiment 61, wherein the surface of the vehicle comprises the main body panels of the vehicle, the windshield and rear window glasses, the tires, the wheels, and/or the side view mirrors.

63. The process of embodiment 61 or 62, wherein the water is added through a hose operating at municipal water supply pressure.

64. The process of embodiment 63, wherein the water exiting the hose provides the agitation for dissolving the composition.

65. The process of any one of embodiments 61-64, wherein applying the solution to the surface of the vehicle comprises using a power washer with a foam cannon.

66. The vehicle cleaning composition of any one of embodiments 1-55, the wash pack of any one of Embodiments 56-60, or the process of any one of Embodiments 61-65, wherein the composition cleans the vehicle without damaging its exterior surface and its acrylic coating at high temperature over time, for example, 85° C. for 15 mins.

67. The vehicle cleaning composition, the wash pack, or the process of embodiment 66, wherein the composition is safe on external coatings such as wax, ceramic, and graphene.

68. A method of preparing the vehicle cleaning composition of any one of embodiments 1-55, the method comprising adding each of the components of the composition to a container and mixing the components to form a composition.

69. A method of preparing the vehicle cleaning composition of any one of embodiments 1-55, the method comprising adding each of the components of the composition, except for the fragrance and dye, to a container and mixing the components to form a composition, and adding the fragrance source and dye to the composition and mixing the composition.

70. The method of embodiment 68 or 69, wherein the method further comprises preparing a wash pack of any one of Embodiments 56-60 comprising the composition of any one of Embodiments 1-55.

### EXAMPLES

Representative embodiments of the present invention will now be described with reference to the following examples that illustrate the principles and practice of the present invention.

Vehicle cleaning compositions in the form of a solid were prepared as shown in the Examples below.

### Example 1

| | | Component |
|---|---|---|
| Component | Function | Quantity |
| Citric Acid (Powder) | Chelating Agent | 0.50 |
| Sugar (Granular) | Builder/Foam Stabilizer | 24.05 |
| Sodium Bicarbonate | Builder | 35.00 |
| (Powder) | | |
| Sodium Carbonate (Powder) | Builder | 0.00 |
| Sodium (C10-16) Alkyl | Surfactant | 10.00 |
| Benzene Sulfonate (granular) | | |
| Sodium Lauryl Sulfate | Surfactant | 30.00 |
| (granular) | | |
| Sodium Xylene Sulfonate | Hydrotropic Additive | 0.00 |
| Fragrance (Liquid) | Fragrance | 0.35 |
| Dye (Liquid) | Dye | 0.10 |
| Total | | 100.00 |

### Example 2

| | | Component |
|---|---|---|
| Component | Function | Quantity |
| Citric Acid (Powder) | Chelating Agent | 0.50 |
| Sugar (Granular) | Builder/Foam Stabilizer | 24.05 |
| Sodium Bicarbonate | Builder | 35.00 |
| (Powder) | | |
| Sodium Carbonate (Powder) | Builder | 0.00 |
| Sodium (C10-16) Alkyl | Surfactant | 20.00 |
| Benzene Sulfonate (granular) | | |
| Sodium Lauryl Sulfate | Surfactant | 20.00 |
| (granular) | | |
| Sodium Xylene Sulfonate | Hydrotropic Additive | 0.00 |
| Fragrance (Liquid) | Fragrance | 0.35 |
| Dye (Liquid) | Dye | 0.10 |
| Total | | 100.00 |

### Example 3

| | | Component |
|---|---|---|
| Component | Function | Quantity |
| Citric Acid (Powder) | Chelating Agent | 0.50 |
| Sugar (Granular) | Builder/Foam Stabilizer | 24.05 |
| Sodium Bicarbonate | Builder | 35.00 |
| (Powder) | | |
| Sodium Carbonate (Powder) | Builder | 0.00 |
| Sodium (C10-16) Alkyl | Surfactant | 30.00 |
| Benzene Sulfonate (granular) | | |
| Sodium Lauryl Sulfate | Surfactant | 10.00 |
| (granular) | | |
| Sodium Xylene Sulfonate | Hydrotropic Additive | 0.00 |
| Fragrance (Liquid) | Fragrance | 0.35 |
| Dye (Liquid) | Dye | 0.10 |
| Total | | 100.00 |

### Example 4

| | | Component |
|---|---|---|
| Component | Function | Quantity |
| Citric Acid (Powder) | Chelating Agent | 37.28 |
| Sugar (Granular) | Builder/Foam Stabilizer | 0.00 |
| Sodium Bicarbonate | Builder | 0.00 |
| (Powder) | | |
| Sodium Carbonate (Powder) | Builder | 37.28 |
| Sodium (C10-16) Alkyl | Surfactant | 25.00 |
| Benzene Sulfonate (granular) | | |
| Sodium Lauryl Sulfate | Surfactant | 0.00 |
| (granular) | | |
| Sodium Xylene Sulfonate | Hydrotropic Additive | 0.00 |
| Fragrance (Liquid) | Fragrance | 0.35 |
| Dye (Liquid) | Dye | 0.10 |
| Total | | 100.00 |

### Example 5

| | | Component |
|---|---|---|
| Component | Function | Quantity |
| Citric Acid (Powder) | Chelating Agent | 0.00 |
| Sugar (Granular) | Builder/Foam Stabilizer | 24.55 |
| Sodium Bicarbonate | Builder | 0.00 |
| (Powder) | | |
| Sodium Carbonate (Powder) | Builder | 0.00 |
| Sodium (C10-16) Alkyl | Surfactant | 50.00 |
| Benzene Sulfonate (granular) | | |
| Sodium Lauryl Sulfate | Surfactant | 20.00 |
| (granular) | | |
| Sodium Xylene Sulfonate | Hydrotropic Additive | 5.00 |
| Fragrance (Liquid) | Fragrance | 0.35 |
| Dye (Liquid) | Dye | 0.10 |
| Total | | 100.00 |

### Example 6

| | | Component |
|---|---|---|
| Component | Function | Quantity |
| Citric Acid (Powder) | Chelating Agent | 0.03 |
| Sugar (Granular) | Builder/Foam Stabilizer | 24.52 |
| Sodium Bicarbonate | Builder | 25.00 |
| (Powder) | | |
| Sodium Carbonate (Powder) | Builder | 0.00 |
| Sodium (C10-16) Alkyl | Surfactant | 50.00 |
| Benzene Sulfonate (granular) | | |
| Sodium Lauryl Sulfate | Surfactant | 0.00 |
| (granular) | | |
| Sodium Xylene Sulfonate | Hydrotropic Additive | 0.00 |
| Fragrance (Liquid) | Fragrance | 0.35 |
| Dye (Liquid) | Dye | 0.10 |
| Total | | 100.00 |

The compositions of Examples 1-6 were prepared by adding each of the components of the composition to a container and mixing the components in the container. The fragrance and dye can be added together with the other components. The fragrance and dye can also be added and mixed into the composition after mixing all the other components.

What is claimed is:

1. A vehicle cleaning composition comprising:
(i) at least one builder and/or foam stabilizer;
(ii) at least one surfactant selected from the group consisting of anionic surfactant and amphoteric surfactant; and
(iii) at least one chelating agent;
and optionally:
(iv) a fragrance source; and/or
(v) a dye;
wherein, the composition is in the form of a solid.

2. The vehicle cleaning composition of claim 1, wherein the builder and/or foam stabilizer is selected from the group consisting of sodium carbonate, sodium bicarbonate, and one or more sugars.

3. The vehicle cleaning composition of claim 1, wherein the sugar is selected from the group consisting of monosaccharides, disaccharides, and polysaccharides.

4. The vehicle cleaning composition of claim 3, wherein the monosaccharide is selected from the group consisting of glucose, fructose, and galactose, or wherein the disaccharide is selected from the group consisting of sucrose, lactose, and maltose.

5. The vehicle cleaning composition of claim 1, wherein the anionic surfactant comprises an alkali metal salt or an ammonium salt.

6. The vehicle cleaning composition of claim 5, wherein the alkali metal salt is selected from the group consisting of sodium C₈-C₂₂ alkyl sulfate, potassium C₈-C₂₂ alkyl sulfate, ammonium C₈-C₂₂ alkyl sulfate, sodium C₈-C₂₂ alkyl benzene sulfate, potassium C₈-C₂₂ alkyl benzene sulfate, ammonium C₈-C₂₂ alkyl benzene sulfate, sodium lauryl sulfate, sodium C₈-C₂₂ alkyl sarcosinate, and an α-olefin sulfonate of the formula 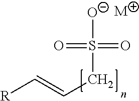
wherein R is an C₈-C₂₂ alkyl group, M⁺ is Na⁺ or K⁺ and n is 1 or 2.

7. The vehicle cleaning composition of claim 1, wherein the amphoteric surfactant is selected from the group consisting of betaines, fatty alkyl imidazoline derivatives, and alkyl amine oxides.

8. The vehicle cleaning composition of claim 7, wherein the betaine is:
(i) an alkyl betaine of the formula 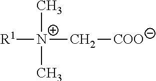
wherein R¹ is a C₆-C₂₂ alkyl group; or
(ii) an alkylamidopropyl betaine of the formula 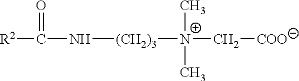
wherein R² is a C₆-C₂₂ alkyl group.

9. The vehicle cleaning composition of claim 7, wherein the fatty alkyl imidazoline derivative is:
(i) an alkylamphodiacetate of the formula 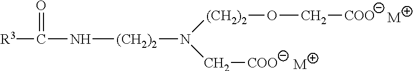
wherein R³ is a C₆-C₁₄ alkyl group, and M is sodium or potassium;
(ii) an alkylamphodipropionate of the formula 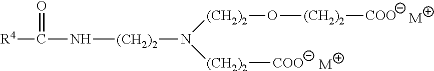
wherein R⁴ is a C₆-C₁₄ alkyl group, and M is sodium or potassium; or
(iii) an alkyliminodipropionate of the formula 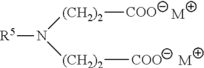
wherein R⁵ is a C₈-C₁₆ alkyl group, and M is sodium or potassium.

10. The vehicle cleaning composition of claim 9, wherein the alkylamphodiacetate is disodium or dipotassium lauroamphodiacetate, wherein the alkylamphodipropionate is disodium or dipotassium lauroamphodipropionate, and wherein the alkyliminodipropionate is sodium or potassium alkyliminodipropionate.

11. The vehicle cleaning composition of claim 7, wherein the alkyl amine oxide has the formula 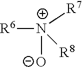
wherein R⁶ is a C₈-C₂₂ alkyl group, and R⁷ and R⁸ are independently a C₁-C₆ alkyl group; or
wherein the alkyl amine oxide is lauryldimethylamine oxide.

12. The vehicle cleaning composition of claim 1, wherein the chelating agent comprises at least one selected from the group consisting of citric acid, tetrasodium ethylenediaminetetraacetate, and tetrasodium glutamate diacetate.

13. The vehicle cleaning composition of claim 1, wherein the fragrance source is natural or synthetic, is in a solid or a liquid form, and/or comprises citrus and/or green notes.

14. The vehicle cleaning composition of claim 1, wherein the dye is a natural or synthetic dye and/or is in the form of a solid or liquid.

15. The vehicle cleaning composition of claim 1, wherein the composition comprises:
(i) sodium carbonate, sodium C₁₀-C₁₆ alkyl benzene sulfonate, citric acid, fragrance source, and dye;
(ii) sodium bicarbonate, sugar, sodium C₁₀-C₁₆ alkyl benzene sulfonate, sodium lauryl sulfate, citric acid, fragrance source, and dye;
(iii) sodium bicarbonate, sugar, C₁₀-C₁₆ alkyl benzene sulfonate, sodium lauryl sulfate, citric acid, fragrance source, and dye;
(iv) sodium bicarbonate, sugar, sodium C₁₀-C₁₆ alkyl benzene sulfonate, sodium lauryl sulfate; citric acid, fragrance source, and dye; or
(v) sodium bicarbonate, sugar, sodium C₁₀-C₁₆ alkyl benzene sulfonate, citric acid, fragrance source, and dye.

16. A vehicle cleaning composition comprising:
(i) at least one builder and/or foam stabilizer, and optionally wherein the at least one builder and/or foam stabilizer is selected from the group consisting of one or more sugars, sodium carbonate, and sodium bicarbonate;
(ii) at least one surfactant, and optionally wherein the at least one surfactant is selected from the group consisting of anionic surfactants and amphoteric surfactants, and optionally wherein the anionic surfactant is selected from the group consisting of sodium C₈-C₂₂ alkyl benzene sulfonate and sodium C₈-C₂₂ alkyl sulfate; and
(iii) at least one hydrotropic additive;
and optionally:
(iv) a fragrance source; and/or
(v) a dye;
wherein, the composition is in the form of a solid.

17. The vehicle cleaning composition of claim 16, wherein the sodium C₈-C₂₂ alkyl benzene sulfonate is sodium C₁₀-C₁₆ alkyl benzene sulfonate, and wherein the sodium C₈-C₂₂ alkyl sulfate is sodium lauryl sulfate.

18. The vehicle cleaning composition of claim 16, wherein the hydrotropic additive is selected from the group consisting of sodium xylene sulfonate, urea, a tosylate, and sodium cumene sulfonate.

19. The vehicle cleaning composition of claim 16, wherein the composition comprises sugar, sodium C₁₀-C₁₆ alkyl benzene sulfonate, sodium lauryl sulfate, sodium xylene sulfonate, fragrance source, and dye.

20. The vehicle cleaning composition of claim 1, wherein the composition is more than 90% (>90%) soluble in water; wherein the composition has a pH of about 5 to about 9 in water; and/or
wherein the composition dissolves in water within about 1 to about 5 minutes at about 50° F. to about 90° F. with or without agitation or wherein the composition creates effervescence or gas bubbles to enhance quick dissolution in water.

21. A vehicle wash pack comprising a unit dose or multiple doses of the composition of claim 1.

22. The vehicle wash pack of claim 21, wherein the unit or multiples doses of the composition is/are sized to wash a car, pick-up truck, or minivan.

23. The vehicle wash pack of claim 21, further comprising a water-soluble hygroscopic polymeric covering enclosing the composition or further comprising a polymeric covering comprising a polyvinyl alcohol (PVA) film.

24. A process for washing the surface of a vehicle comprising:
placing the vehicle cleaning composition of claim 1 into a container; and
adding water to said container to dissolve the composition with or without agitation and prepare a solution for washing the surface of the vehicle; and
applying the solution to the surface of the vehicle.

25. A process for washing the surface of a vehicle comprising:
placing the wash pack of claim 21 into a container; and
adding water to said container to dissolve the composition with or without agitation and prepare a solution for washing the surface of the vehicle; and
applying the solution to the surface of the vehicle.

26. A method of preparing the vehicle cleaning composition of claim 1, the method comprising:
(i) adding each of the components of the composition to a container and mixing the components to form a composition; or
(ii) adding each of the components of the composition, except for the fragrance and dye, to a container, mixing the components to form a composition, and subsequently adding the fragrance source and dye to the composition and further mixing the composition;
and optionally, wherein the method further comprises putting the composition into a wash pack.
